(19) United States
(12) Patent Application Publication
(10) Pub. No.: US 2003/0030027 A1
(43) Pub. Date: Feb. 13, 2003

(54) Magnetizable coating composition

(76) Inventors: R. William Graham, Kettering, OH (US); Daniel F. Peters, Hamilton, OH (US); Charles E. Adams, Dayton, OH (US); Ricky L. Helton, Mason, OH (US)

Correspondence Address: R. William Graham, 22 S. St. Clair Street, Dayton, OH, 45402, US

(21) Appl. No.: 09/919,227

(22) Filed: Jul. 31, 2001

(51) Int. Cl. H01F 1/00

(52) U.S. Cl. 252/62.54; 252/62.53; 427/598; 427/599; 427/127; 427/130; 427/128

(57) ABSTRACT

The present invention includes magnetizable coating composition for application to a substrate. The coating composition includes a plurality of strontium and or barium hexaferrite particles having a random magnetic pole alignment. The coating composition also includes a binder adhesive capable of suspending the strontium hexaferrite particles. The binder adhesive is a latex capable of adhering in a substantially thin film to the substrate. The strontium hexaferrite particles are normally present between 50% to 98% of the coating composition's total weight when dried on the substrate. The thickness of the film of the coating composition is at least about 0.5 mils thick, and has 6 to 24 magnetic pole changes per linear inch. The binder adhesive allows for manipulation of the strontium hexaferrite particles to a non-random magnetic pole alignment after the ferromagnetic particles have dried in the binder adhesive on the substrate.

### FIELD OF INVENTION

This invention relates to the art of adhering a magnet to a substrate, and more particularly, the present invention relates to a coating composition having a random magnetic pole alignment able to be directly applied to a substrate, dried, and then magnetized such that the coating composition has a non-random magnetic pole alignment (aligned magnetic poles).

### BACKGROUND

Traditionally, magnet compositions, made up of magnetic or magnetizable materials, (e.g., ferromagnetic material) and flexible resins have been used to form conventional flexible magnets by using several methods including compaction molding, injection molding, and extrusion molding.

The various methods used to produce flexible magnets include several complex, cost prohibitive steps. For instance, in compaction molding, a compound is packed in a press mold and compacted at a room temperature so as to form a green body. Subsequently, when the binding resin is a thermosetting resin, the resin is hardened, whereby a magnet is obtained. Extrusion molding is a method in which heated molten compound extruded from an extruder die is solidified by cooling and then cut at a desired length, whereby a magnet is obtained. In injection molding, a compound, which has been heated and molten to exhibit sufficiently high fluidity, is poured into a mold so as to form a magnet of a desired shape. Once the magnets are produced and readied for a particular substrate, there are several additional steps involved in adhering the magnet and the substrate together. For these reasons, it is desirable to apply a magnetizable coating directly to the substrate in one step.

In U.S. Pat. No. 3,503,882, Fitch disclosed a paint composition containing iron powder and an epoxy ester resin with an emulsifiable polyethylene wax and an organophilic alkyl ammonium bentonite dispersed in a paint hydrocarbon solvent when applied to a substrate and dried, a surface to which magnetic symbols will adhere and which will accept chalk markings. The iron powder employed in the oil-based paint formulation was rather coarse, at least 100 to 200 mesh, with over half preferably over 200 mesh, and comprising from about 70 to about 85% by weight, based on the combined weight of the iron powder and epoxy ester resin. Thus, the product was so coarse that it was brushed on, rather than rolled or sprayed, and fumes from the paint solvent are currently regarded as toxic.

In U.S. Pat. No. 5,587,102, Stem and Treleaven disclosed a magnetic latex paint composition comprising a carrier, particulate magnetically permeable material, a binder and a thickening agent having thixotropic and viscosity characteristics such that the paint composition has high viscosity characteristics when stationary, and low viscosity when shear forces to the paint as it is applied to a wall surface. Particulate iron no smaller than 350 mesh was employed with synthetic clay as a thickening agent to keep particles in suspension. Thus formulated, drying retarders were necessary so that a smooth surface after paint application could be achieved without lap marks. When the paint dried, magnetic objects could be mounted on the surface, held in place by the interaction with the magnetically permeable material.

While previous patents teach of magnetic paints and coatings, there fails to be a suitable magnetic coating composition capable of being suitably magnetized once dried on the substrate. A magnetizable coating composition allows for the wet coating composition, having a simplistic binder adhesive formulation, to contain a relatively high percentage (such as 80-90% by weight of the wet coating composition) of ferromagnetic particles without the occurrence of clumping. Another advantage to a magnetizable coating composition is a user's ability to reasonably determine the degree of magnetization that he or she wishes to give the coating composition once dried on the substrate.

### SUMMARY OF THE INVENTION

The present invention includes magnetizable coating composition for application to a substrate. The coating composition includes a plurality of ferromagnetic particles having a random magnetic pole alignment and a binder adhesive capable of suspending the ferromagnetic particles. The binder adhesive is capable of adhering in a substantially thin film to the substrate. The binder adhesive allows for manipulation of the ferromagnetic particles to a non-random magnetic pole alignment after the ferromagnetic particles have dried in the binder adhesive on the substrate.

### TERMINOLOGY

“Magnet” is a body, as a piece of iron or steel, that possess the property of attracting certain substances, as iron; a thing that attracts.

“Magnetize” is to make a magnet of; impart the properties of a magnet to; to exert an attracting or compelling influence.

### DETAILED DESCRIPTION OF THE INVENTION

The present invention consists of a magnetizable coating composition. The coating composition is made up of a ferromagnetic particles and a binder adhesive. This invention is based upon the finding that large quantities of certain ferromagnetic particles, having a random magnetic pole alignment, may be suspended by particular binder adhesives without clumping. The resulting coating composition is able to be applied to a substrate in a relatively thin film. The dried film is able to be manipulated to allow for the ferromagnetic particles to be magnetized, thus have a relatively non-random magnetic pole alignment.

The ferromagnetic particles with randon pole alignment of the preferred embodiment can include strontium hexaferrite (SrFe₁₂O₁₉) and/or barium hexaferrite (BaFe₁₂O₁₉). However, the ferromagnetic particles can be selected from a wide variety of iron, nickel and cobalt compounds that have ferromagnetic capacity. For instance, most of the ferrites of the general formula MeO.Fe.sub.2 O.sub.3, in which Me is a metal, can be used as the magnet powder. Barium ferrite, BaO:6Fe.sub.2 O.sub.3, is a variation of the basic magnetic iron-oxide magnetite which has a hexagonal crystalline form and is very useful as the ferromagnetic particles. Barium ferrite can be magnetically aligned. It also has a very high uniaxial magnetic anisotropy capable of producing high values of coercive force (Hc). For a permanent magnet to retain its magnetization without loss over a long period of time, the coercive force should be as high as possible. Powdered strontium ferrite is also useful as the magnet powder. Alloys of nickel and iron, known as permalloy, have a maximum saturation magnetization in cases where the alloy contains about 50 percent nickel and 50 percent iron and are useful in powdered form as the ferromagnetic particles. The ferromagnetic particles will typically have a particle size which is within the range of about 0.1 to about 10 microns. The ferromagnetic particles will more typically have a particle size which is within the range of about 1 to about 5 microns.

In lieu of ferrite particles, the coating composition can contain rare earth magnet or magnetizable particles. By the term “rare earth magnet or magnetic material,” it is meant any magnetic material or magnetizable material which contains at least one rare earth element therein, that is an element having an atomic number of from 57 to 71. Such elements can be contained in either minor or major amounts. Such rare earth magnets can contain minor or major amounts of non rare earth elements such as iron, cobalt, nickel, boron, and the like. Another definition of rare earth magnetic materials are compositions, that is alloys and/or mixtures, containing one or more rare earth elements which generally have good magnetic properties, that is magnetic properties such as generating a magnetic force which is greater than that obtained utilizing conventional non-rare earth magnets such as alloys of nickel, iron, and cobalt. Often times the residual induction value (B.sub.r) of the rare earth magnets is 25 percent greater than that generated by conventional non-rare earth magnet materials such as barium ferrite.

Rare earth magnets are described in various articles and especially in patents such as U.S. Pat. No. 4,496,395 to Croat, U.S. Pat. No. 4,558,077 to Gray, U.S. Pat. No. 4,597,938 to Matsuura et al., U.S. Pat. No. 4,601,875 to Yamamoto et al., U.S. Pat. No. 4,684,406 to Matsuura et al., European patent application No. 108,474 to General Motors, and European patent application Nos. 106,948 and 134,304 to Sumitomo Special Metals Company Ltd., all of which are hereby fully incorporated by reference with regard to the rare earth magnet compositions, methods of preparation, and the like disclosed therein and can be used in compbination with the present invention.

A large class of rare earth magnet or magnetic materials are various alloys of iron, boron, at least one rare earth element, and optionally cobalt. Other rare earth magnet compositions are set forth in “Rare Earth Permanent magnets,” E. A. Nesbitt and J. H. Wernick, Academic Press, New York, 1973, which is hereby fully incorporated by reference. Other rare earth patents are set forth in U.S. Pat. Nos. 4,869,964, 4,988,755, 5,051,200, and 5,173,206, which are hereby fully incorporated by reference with regard to all aspects thereof.

The amount of the rare earth magnet or magnetizable particles in the preferred embodiment is generally high, such that generally from about 55 to about 70 percent, desirably from about 58 to about 65 and preferably from about 55 to about 62 percent by volume can be utilized based upon the total wet volume of the rare earth particles and the binder adhesive. Ultimately, it is essential that the magnet or magnetizable particles used in the coating composition have a random magnetic pole alignment. In other words, it is essential that the magnet or magnetizable particles used in the coating composition do not attract each other.

A binder adhesive of the preferred embodiment is latex composition. The contents of the latex composition may vary depending upon the desired use of the invention. For instance, commercial applications would require a fast drying version of the invention. The contents of the latex composition would preferably include natural rubber dispersed in synthetic, organic, and hydrocarbon solvents and diluents. Alternatively, for non-commercial applications, a slow drying version of the invention would suffice. The contents of the latex composition would preferably include synthetic and or natural resins, water, amines, surfactants, solvents, and diluents.

There are various methods of applying the coating composition to a substrate. For instance, the coating composition may be applied using rollers, brushes, squeeze tubes, spatulas, injection devices, and all such related devices. The application(s) may result in a thin film or a coating of the coating composition. Additionally, it is foreseen, especially for non-commercial use, that the coating composition could be packaged in tubes or cans. The coating composition may be applied at room temperature.

Examples of general substrates which the coating composition may be applied to include paper, plastic, cloth, leather, wood, metal, glass, synthetic composites, organic composites, and like such materials. More specifically, the coating composition may be applied to business cards, signs, labels, photographic paper, stencils, and like such materials.

The coating composition must be dried on the substrate before non-random magnetic pole field alignment can achieved. Most conventional methods of drying or baking will work. The substrate with the dried and leveled coating composition is then passed over either fixed magnets or electromagnets. The greater the number of magnetic pole changes per linear inch increases the magnetic holding properties of the finished product. The minimum number of magnetic pole changes per linear inch is about 4. Although, about 8 to 12 magnetic pole changes per linear inch is recommended for adequate magnetic holding power. The maximum pole changes per linear inch, with current available technology, is about 32. The holding power of the coating composition may be such that the coating composition is used for holding the weight of the coating composition, as well as the substrate which it is adhered to, in a removable substantially fixed position to a surface, in opposition to gravitational force. However, when the substantially fixed position is not in opposition to gravitation force, the coating composition may serve the function of holding a substrate in a removable substantially fixed position against the external forces applied to the substrate during its intended use (e.g., the forces exerted upon carpet by the person walking over the carpet).

Beyond holding power, it is understood the coating composition may be magnetized for the purpose of communicating information (e.g., magnetizable credit card strips to be read by a reading device, magnetizable security strips capable of tripping an alarm, etc.). Additionally, it is foreseen that commonly painted strips in the middle of the road may be magnetized provide information to vehicles.

The thickness of the coating composition may be built up by the application of multiple coats or layers. Minimum thickness of the coating composition is determined by the number of magnetic field pole changes per linear inch, the percent by volume or weight of the ferromagnetic material, and the substrate. For instance, the thickness of the coating composition may range from 0.5 mils to 20 mils. It should be understood that the previously mentioned range is not meant to limit, but to illustrate a range of common thicknesses for some applications. It is foreseen that a coating composition may be greater or less than the range previously stated. The coating composition should be made to a uniform thickness. Uniform thickness of the coating composition can be achieved by the use of rollers, nip rollers, bars, doctor blades, buffing, burnishing, sanding, or any such related method. It is understood that the coating composition may be applied to form a continuous film or coating, as well as a non-continuous film or coating. A non-continuos film or coating may be in a non-random or random pattern.

Additionally, it is foreseen in a single continuous process that a removable adhesive may be applied to the dried coating composition by conventional coating methods. The adhesive would be similar, but not limited to the adhesive used on Post-It® notes. A release liner sheet would be applied on top of the adhesive. With this configuration of construction, this product would adhere to ferrous surfaces by magnetic attraction and by removing the release liner sheet the product would adhere to non-ferrous surfaces.

The invention will be better understood by reference to the following examples which serve to illustrate but not to limit the scope of the present invention.

### EXAMPLES

### Example 1

Wet Form

| | | | | |
|---|---|---|---|---|
| Bondrite 428 ® | 35-40% | by weight | 11-13% | solids |
| Strontium Hexaferrite | 60% | by weight | 100% | solids |
| Heptane/Hexane | 0.0-5% | by weight | 100% | volatile |

### Example 2

Wet Form

| | | | | |
|---|---|---|---|---|
| Bondrite 428 ® | 35-40% | by weight | 11-13% | solids |
| Strontium Hexaferrite | 60% | by weight | 100% | solids |
| Ethyl acetate | 0.0-5% | by weight | 100% | volatile |

While the present invention has been described in detailed embodiments, it will be appreciated and understood that modification may be made without departing from the true spirit and scope of the invention.

What is claimed is:

1. A magnetizable coating composition for application to a substrate, said coating composition comprising:
a plurality of ferromagnetic particles having a random magnetic pole alignment; and
a binder adhesive capable of suspending said ferromagnetic particles, said binder adhesive capable of adhering to the substrate;
wherein said binder adhesive allows for manipulation of said ferromagnetic particles to a non-random magnetic pole alignment after said ferromagnetic particles have dried in said binder adhesive on the substrate.

2. The magnetizable coating composition of claim 1, wherein said coating composition is capable of holding the substrate in a removably substantially fixed position to a surface.

3. The magnetizable coating composition of claim 2, wherein said coating composition is able to removably substantially fix the substrate to said surface in opposition to gravitational force.

4. The magnetizable coating composition of claim 2, wherein said coating composition is able to removably substantially fix the substrate to said surface in opposition to forces consistent with the substrates use.

5. The magnetizable coating composition of claim 1, wherein said composition is capable of retaining information in the form of a particular sequence of non-random pole alignments

6. The magnetizable coating composition of claim 1, wherein said composition forms a substantially thin film on the substrate.

7. The magnetizable coating composition of claim 1, wherein said composition forms a coat on the substrate.

8. The magnetizable coating composition of claim 1, wherein said coating composition is arranged in a non-continuous pattern.

9. The magnetizable coating composition of claim 1, wherein said ferromagnetic particles are at least one of strontium hexaferrite and barium hexaferrite.

10. The magnetizable coating composition of claim 1, wherein said binder adhesive is a combination including at least one natural rubber, at least one solvent, and at least one diluent.

11. The magnetizable coating composition of claim 1, wherein said binder adhesive is a combination including at least one resin, at least one amine, at least one solvent, at least one diluent, and water.

12. The magnetizable coating composition of claim 1, wherein said binder adhesive is latex.

13. The magnetizable coating composition of claim 12, wherein said latex includes heptane, hexane, and acetone.

14. The magnetizable coating composition of claim 12, wherein said latex includes ethyl acetate.

15. The magnetizable coating composition of claim 1, wherein said binder adhesive includes Bondrite 428® and heptane.

16. The magnetizable coating composition of claim 1, wherein said coating composition is at least 0.5 mils thick, and said coating composition having 6 to 24 magnetic pole changes per linear inch.

17. The magnetizable coating composition of claim 1, wherein said ferromagnetic particles range between 50% to 98% of said coating composition's total weight when dried on the substrate.

18. A method of applying a magnetizable coating composition for application to a substrate, said method comprising:
(a) applying a coating composition comprising a plurality of ferromagnetic particles having a random magnetic pole alignment, a binder adhesive capable of suspending said ferromagnetic particles, said binder adhesive capable of adhering to the substrate, wherein said binder adhesive allows for manipulation of said ferromagnetic particles to a non-random magnetic pole alignment after said ferromagnetic particles have dried in said binder adhesive on the substrate to the substrate; and
(b) passing a device over said film of said coating composition, said device capable of aligning said poles of said ferromagnetic particles such that said ferromagnetic particles have at least a partially non-random magnetic pole alignment.

19. The method of claim 18, wherein said step (a) is characterized by applying a substantially thin film of said coating composition onto said substrate.

20. The method of claim 18, which further includes the step of drying said coating composition such that said plurality of ferromagnetic particles are substantially evenly dispersed throughout said film prior to step (b).

21. The method of claim 18, which further includes applying a removable adhesive to said dried coating composition having at least a non-random magnetic pole alignment.
